(19) United States
(12) Patent Application Publication
(10) Pub. No.: US 2006/0268995 A1
(43) Pub. Date: Nov. 30, 2006

(54) Video signal processing device and image quality correcting method for the same

(75) Inventor: Keiko Hirayama, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/417,164

(22) Filed: May 4, 2006

(30) Foreign Application Priority Data
May 31, 2005 (JP) 2005-160674

(51) Int. Cl. H04B 1/66

(52) U.S. Cl. 375/240.27

(57) ABSTRACT

An execution state or a suppressing state of an image quality correction even of a signal with an error-detecting code (EDC) not adopted thereto can be controlled. A transport error indicator in a header of a transport stream demodulated from a digital broadcasting signal is detected. It is determined whether or not the transport error indicator indicates a packet error. When the packet error is present on the basis of the determination result, an image quality correcting operation in an image quality correcting unit is suppressed and when the packet error is not present, the image quality correcting operation therein is set to a sufficient execution state.

### CROSS-REFERENCE TO RELATED APPLICATIONS

This application is based upon and claims the benefit of priority from Japanese Patent Application No. 2005-160674, filed May 31, 2005, the entire contents of which are incorporated herein by reference.

### BACKGROUND

1. Field

One embodiment of the invention relates to a video signal processing device and a method for the same, and more specifically, relates to a device and a method for suppressing deterioration in image quality by controlling an image quality correcting unit when a receiving state has deteriorated, for example, in a receiver to receive a digital broadcast signal.

2. Description of the Related Art

The video signal processing device has the image correcting unit. The correcting unit implements contour emphasis, γ correction, histogram correction, black and white expansion and the like on a video signal which has been converted into a base band. The performance of image quality corrections includes a method for executing correction manually and a method for executing correction automatically.

In the method for executing the correction, a user forcibly and manually adjusts the video signal so that the image quality becomes a favorite image quality appropriately while watching a screen. The method for executing the correction automatically sets a range for the correction in advance to adjust the image quality in response to a reception state (for example, signal-to-noise ratio).

A broadcasting receiver involves a method for monitoring an error rate so as to grasp a signal-to-noise ratio situation in error code correction processing with an error-detecting code (EDC) used therein. When the error rate has increased, the user can determine that the signal-to-noise ratio is low, and otherwise, the user can determine that the signal-to-noise ratio is high.

It is better for a contour correction that is one of the image quality corrections to dull the contour when the signal-to-noise ratio is low, and it is better for the contour correction to add emphasis to the contour when the signal-to-noise ratio is high. In other words, since an emphasis of a high area of an image in a large noise environment also emphasizes even noise to degrade the image quality, it is better to suppress high-area components, and an emphasis of the high-area is a possible method so as to fully exhibit performance of the image with a smaller noise.

A technique to perform the contour correction that is one of the image corrections in response to the above-mentioned signal-to-noise ratio situation is disclosed, for example, in Jpn. Pat. Appln. KOKAI Publication No. 8-098153.

A digital broadcasting receiver involves, for example a technique described by Jpn. Pat. Appln. KOKAI Publication No. 2000-299861, as a technique not for a direct image correction but for varying the images in response to error situations. This technique generates an image signal such as a block image in an occurrence of a large error when an image format has changed to perform decoding processing and adds a synchronous signal to the image signal to output it. Thereby, the screen is darken to hide a disturbance in the video on the screen.

In the case of performing an image quality correction in accordance with the signal-to-noise ratio situation, the user can utilize the technique described in Jpn. Pat. Appln. KOKAI Publication No. 8-098153 for a signal with the EDC adopted thereto. In contrast, the technique described therein is not sufficient for a signal with the EDC not adopted thereto.

### BRIEF SUMMARY OF THE INVENTION

According to one embodiment of the invention, a video signal processing device and an image quality correcting method for the same capable of controlling image quality correction processing even for a signal with an error detecting code (EDC) not adopted thereto.

In order to attain the above object, in the embodiment of the invention, a video signal processing device, including a demodulating unit to demodulate a transport stream from a received signal; a processing unit to process a packet of the decoded transport stream; a decoder to decode data of a payload included in the packet; an image quality correcting unit to correct an image quality of a digital video signal that is an output from the decoder; and a reproduction controlling unit to supply a control signal to the image quality correcting unit, comprises a detecting unit to detect transport error indicator in a header of the decoded transport stream packet from a digital broadcast signal; an information determining unit to determine whether or not the detection from the detecting unit has shown a packet error; an overall determining unit to suppress an image quality correcting operation in the image quality correcting unit when the packet error is present in the transport stream packet and to set the image quality correcting operation of the image quality correcting unit to an execution state without suppressing the image quality correcting operation thereof when the packet error is not present in the transport stream packet, as a determination result from the information determining unit.

According to the above-described configuration, the video signal processing device can control the execution state or a suppressing state of the image quality correction even for the signal with the EDC not adopted thereto with reference to the transport error indicator.

Additional objects and advantages of the embodiments will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWINGS

FIG. 1 is an exemplary block diagram showing a configuration of an embodiment of the invention;

FIG. 2 is an exemplary view explaining a format of a transport stream in a terrestrial digital broadcast;

FIG. 3 is an exemplary flowchart showing operations of a reproduction control unit in FIG. 1;

FIG. 4 is another exemplary flowchart showing the operations of the reproduction control unit in FIG. 1; and

FIG. 5 is an exemplary block diagram further showing a configuration of another embodiment of the invention.

### DETAILED DESCRIPTION

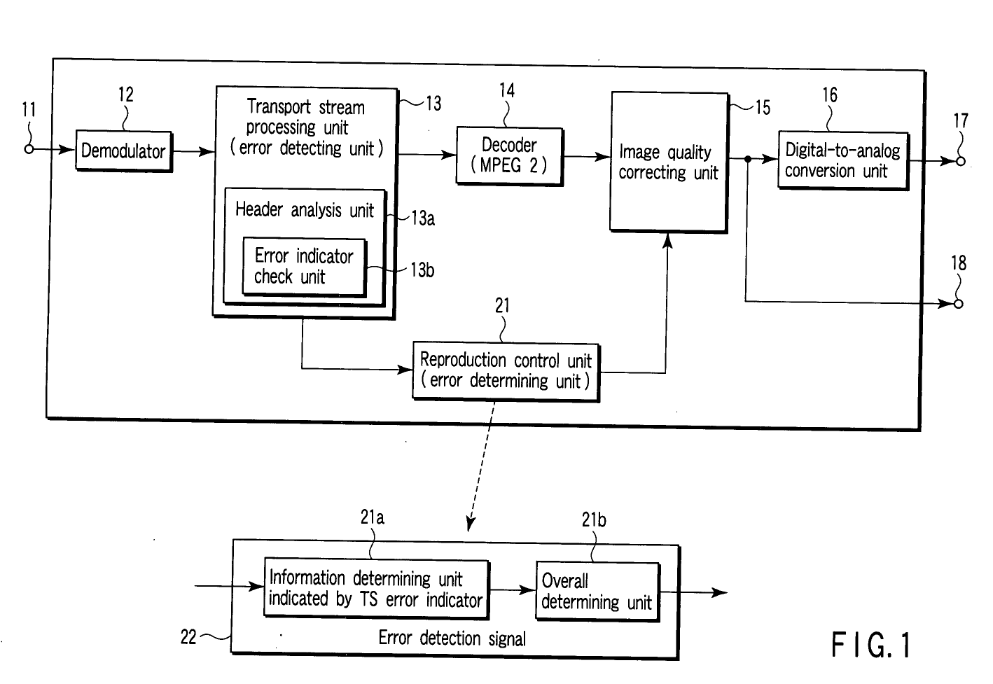

Hereinafter, embodiments of the invention will be described with reference to the drawings. FIG. 1 is one embodiment of the invention and it inputs a digital broadcast signal received at a tuner to a digital demodulator 12 via an input terminal 11. A transport stream (TS) demodulated by the demodulator 12 is input to a transport stream processing unit 13.

In the case where a lot of errors are in present in a packet of the transport stream and an error ratio is larger than the ratio which has been set beforehand, the demodulator 12 can write a flag indicating presences of the errors to a transport error indicator (error display). The error indicator (error display) will be further described later.

The processing unit 13 separates a transport stream packet and analyzes information included in a header in the packet. A payload in the transport stream packet is input to a moving picture experts group-2 (MPEG-2) decoder 14. A video signal of a base band decoded by the decoder 14 is input to an image quality correcting unit 15.

The correcting unit 15 can implement, for example, contour emphasis, γ correction, histogram correction, black and white expansion of the video signal or the like on a video signal. The video signal processed by the correcting unit 15 is output to an analog output terminal 17 via a digital output terminal 16. The video signal output from the correcting unit 15 is output as it is to a digital output terminal 18.

The processing unit 13 has a header analysis unit 13a of the transport stream packet. The analysis unit 13a includes a transport error indicator (error display) check unit 13b. The check result from the error indicator is input to a reproduction control unit 21. The control unit 21 determines whether the check result indicates ‘presence of error’ or ‘absence of error’. An information determining unit 21a produces this determination. The indication of ‘presence of error’ by the control unit 21 switches an error detection signal to one for the presence of the error, and in contrast, the indication of ‘absence of error’ thereby switches it to one for the absence thereof.

Successively, an overall determining unit 21b performs signal processing. That is, when the error detection signal indicates the presence of the error, the determining unit 21b sends, for example, a stop signal to turning off an operation of a contour correcting unit to the image quality correcting unit 15. In contrast, when the error indication signal indicates the absence of the error, the determining unit 21b sends a signal to turning on the operation of the contour correcting unit to the correcting unit 15.

As mentioned above, a video signal processing device of the invention can control the operation of the image quality correcting unit 15 by utilizing contents of the transport error indicator included in a header of the transport stream packet. Therefore, even when any error-detecting code (EDC) is not included in the sent signal, the processing device can control the correcting unit 15 in response to an error situation (signal-to-noise ratio situation) of the signal.

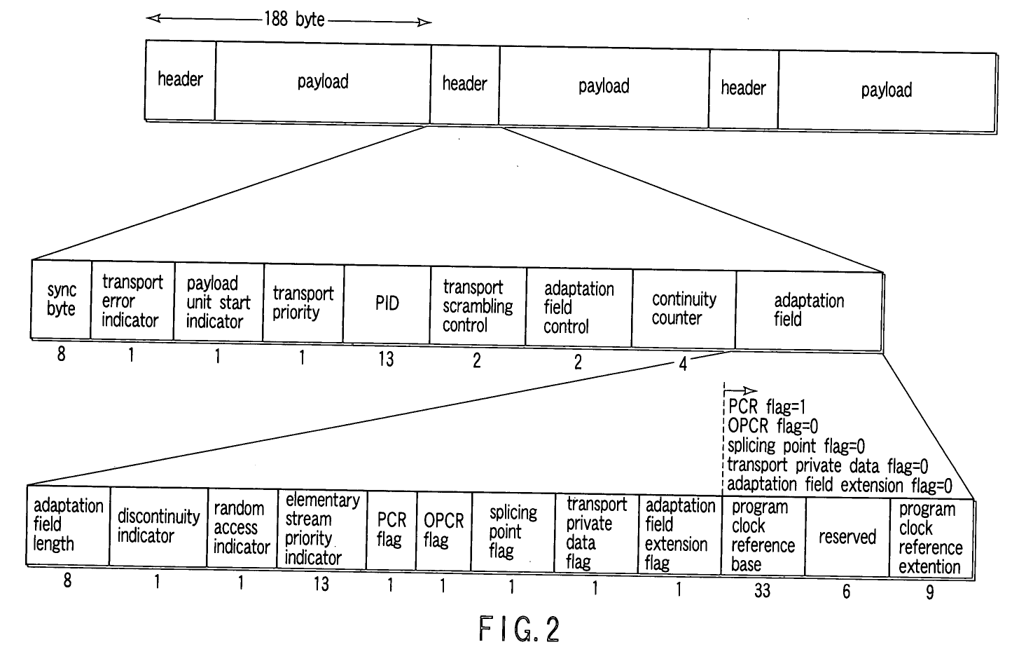

FIG. 2 shows a basic structure of the transport stream and information included in the header for reference. A transport stream packet with a 188-byte has areas of a header and a payload. The header includes a sync byte (8-bit), a transport error indicator (1-bit), a payload unit start indicator (1-bit), a transport priority (1-bit), a packet identifier (PID) (13-bit), a transport scrambling control (2-bit), an adaptation field control (2-bit), a continuity counter (4-bit) and an adaptation field (76-bit).

The transport error indicator indicates whether or not the packet is an error packet. The payload unit start indicator indicates whether or not the payload starts from the packet. The transport priority is utilized to indicate the priority order in transmission. The PID is an identifier of the packet in the transport stream. The type of packet includes a null packet for stuffing, a packet of a program association table (PAT), a condition access table (CAT) or the like. The transport scrambling control is utilized for indicating the fact that the payload has been scrambled. The adaptation field control shows whether an adaptation field has continued or not. The continuity counter is utilized to show a continuity of packets at every PID. At every coming of TS packets with the same PID, the continuity counter increments itself. When the count remakes 15, the continuity counter returns to zero.

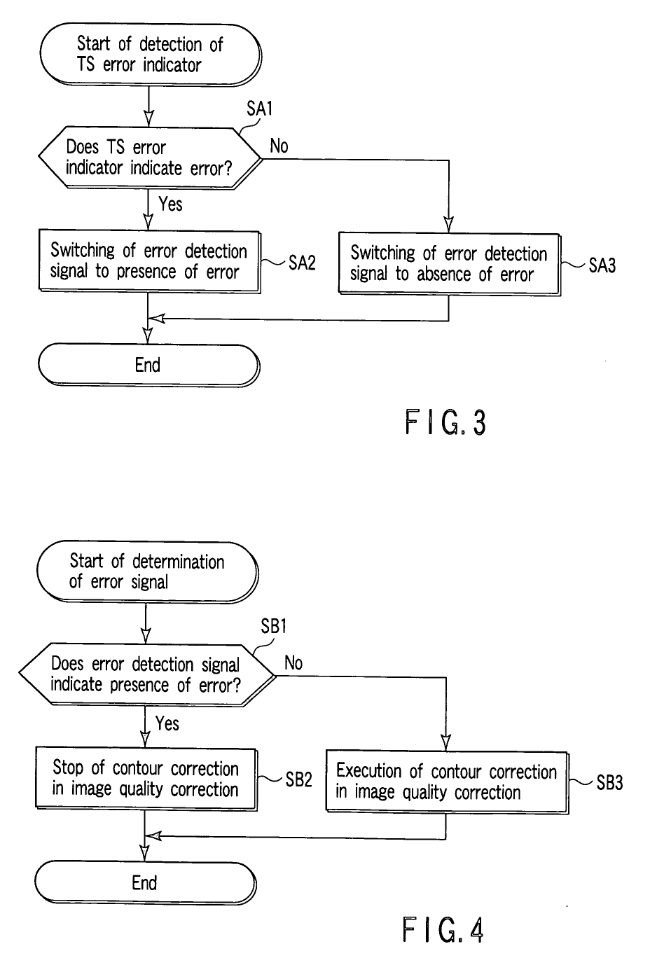

FIG. 3 is an exemplary flowchart showing operations on a side of the information determining unit 21a of the reproduction control unit 21. The determining unit 21a whether or not the error indicator indicates the presence of the error (step SA1), then, when it indicates the presence thereof, the determining unit 21a switches the error detection signal to the one indicating the presence of the error (step SA2) and when it indicates the absence of the error, it switches the error detection signal to the one indicating the absence of the error (step SA3).

FIG. 4 is an exemplary flowchart showing operations on a side of the overall determining unit 21b of the reproduction control unit 21. When the aforementioned error detection signal indicates the presence of the error, the determining unit 21b outputs an instruction to stop the contour correction to the image quality correcting unit 15 (steps SB1 and SB2), and when it indicates the absence of the error, the determining unit 21b outputs an instruction to execute the contour correction to the correcting unit 15 (steps SB2 and SB3).

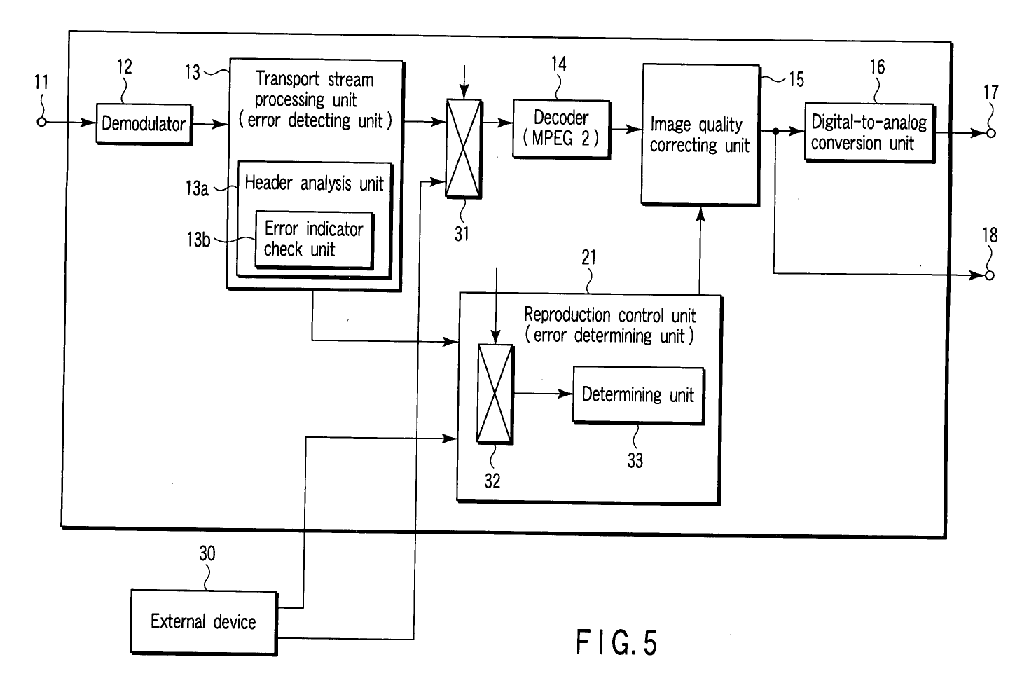

FIG. 5 shows another embodiment of the invention. Elements similar to those of FIG. 1 are given like reference marks. A selector 31 is disposed between the transport stream processing unit 13 and the decoder 14. The selector 31 can select an MPEG-2 signal from an external device 30 by a switching signal from a control unit (not shown) and supply it to the decoder 14. On the other hand, the reproduction control unit 21 is also provided with a selector 32. The selector 32 can receive error information showing an error situation of a signal from the external device 30 by the switching signal from the control unit (not shown) and supply it to a determining unit 33. The determining unit 33 basically includes the information determining unit 21a and the overall determining unit 21b shown in FIG. 1. Therefore, the reproduction control unit 21 can perform the operations described for FIG. 3 and FIG. 4. That is to say, the reproduction control unit 21 controls the image quality correcting state of the image quality correcting unit 15 in response to the error information from the outside.

In this embodiment, furthermore, if errors have increased in number in decoding the signal from the external device 30, the determining unit 33 determines whether or not the errors exceed a threshold and are present within a prescribed area, and if the errors fit their conditions, it stops the image quality correcting processing in the image quality unit 15 or conducts a correction to lower the image quality (correction to suppress higher components).

Digital recording equipment, for example, a hard disk drive or a DVD recording/reproducing device is usable as the external device. As error information, the error information acquired in error correction processing by using an error-correcting code (ECC) is available.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A video signal processing device, comprising:
a demodulating unit to demodulate a transport stream from a received signal;
a processing unit to process a packet of the demodulated transport stream;
a decoder to decode data of a payload included in the packet;
an image correcting unit to correct an image quality of a digital video signal that is an output from the decoder;
a detecting unit to detect a transport error indicator in a header of the demodulated transport stream packet from a digital broadcasting signal;
an information determining unit to determine whether or not the transport error indicator indicates a packet error as a detection result from the detecting unit; and
an overall determining device to set an image quality correcting operation of the image quality correcting unit to an execution state which is more suppression the image quality correcting operation than suppression thereof when the packet error is not present in the transport stream packet, as a determination result from the information determining unit.

2. The video signal processing device according to claim 1, wherein the overall determining unit controls a contour correcting circuit of the image quality correcting unit.

3. The video signal processing device according to claim 1, wherein the decoder can be input an encoded video signal from an outside via a first selector.

4. The video signal processing device according to claim 3, further comprising:
a second selector to selectively taking in error information from an outside or detection information from the transport error indicator; and
a determining unit including the information determining unit and the overall determining unit to control an execution of the image quality correcting operation of the image quality correcting unit in response to the error information from the outside.

5. The video signal processing device according to claim 1, wherein the processing unit to process the packet of the transport stream has an analysis unit to analyzes a header of the packet and to check the transport error indicator

6. An image correcting method for a video signal processing device which includes a demodulator unit to demodulate a transport stream from a received signal; a processing unit to process a packet of the demodulated transport stream; a decoder to decode data of a payload included in the packet; an image quality correcting unit to correct an image quality of a digital video signal that is an output from the decoder; and a reproduction control unit to supply a control signal to the image quality correcting unit, comprising:
detecting, by the processing unit from a digital broadcasting signal, a transport error indicator in a header of the packet of the demodulated transport stream;
determining, by the reproduction control unit, whether or not the transport error indicator indicates a packet error, as a detection result from the transport error indicator; and
suppressing an image quality correcting operation in the image quality correcting unit when the packet error is present in the transport stream packet and setting the image quality correcting operation of the image quality correcting unit to an execution state without suppressing the image quality correcting operation thereof, as a determination result from the reproduction control unit.

7. The image quality correcting method for the video signal processing device according to claim 6, wherein the image quality correcting operation in the image quality correcting unit is a contour correction.

8. The image quality correcting method for the video signal processing device according to claim 6, wherein the decoder can be selectively input an encoded video signal from an outside.

9. The image quality correcting method for the video signal processing device according to claim 8, further comprising:
selectively taking in error information from an outside or detection information from the transport error indicator; and
controlling an execution of the image quality correcting operation of the image quality correcting unit in response to the error information form the outside.

10. The image quality correcting method for the video signal processing device according to claim 6, further comprising analyzing a header of the packet to check the transport error indicator by the processing unit to process the packet of the demodulated transport stream.
